(19) United States
(12) Patent Application Publication
(10) Pub. No.: US 2010/0127225 A1
(43) Pub. Date: May 27, 2010

(54) Card Puller

(76) Inventor: Gail T. Mika-Duesler, Divide, CO (US)

Correspondence Address: HANES & SCHUTZ, LLC, 102 SOUTH TEJON ST., SUITE 800, COLORADO SPRINGS, CO, 80903, US

(21) Appl. No.: 12/323,671

(22) Filed: Nov. 26, 2008

(51) Int. Cl. B66F 13/00; A45C 11/00

(52) U.S. Cl. 254/1; 150/147

(57) ABSTRACT

A card puller is usable for retrieving a card from a card pocket. The card puller has an elongated handle and a gripping surface. The gripping surface is disposed near one end of the elongated handle. The gripping surface against the card has a sufficient coefficient of friction to pull the card from the card pocket as the elongated handle is withdrawn from the card pocket.

### BACKGROUND

Credit cards and identification cards are often stored in special card pockets in wallets and pocketbooks. Retrieving these cards from the card pockets is sometimes difficult, as often a person must be able to reach a finger into the pocket and pull the card out. This may be a difficult physical out for some people. Other people may find it difficult to do so if they have freshly painted fingernails, because reaching into the pocket may disturb fingernail paint that has not yet fully dried.

### DESCRIPTION OF THE DRAWINGS

FIG. 1 is an illustration of a card puller according to one embodiment.

FIG. 2 is a perspective view of the card puller according to one embodiment.

FIG. 3 is a cross-sectional diagram with proportions exaggerated in order to illustrate the use of the card puller.

### DETAILED DESCRIPTION

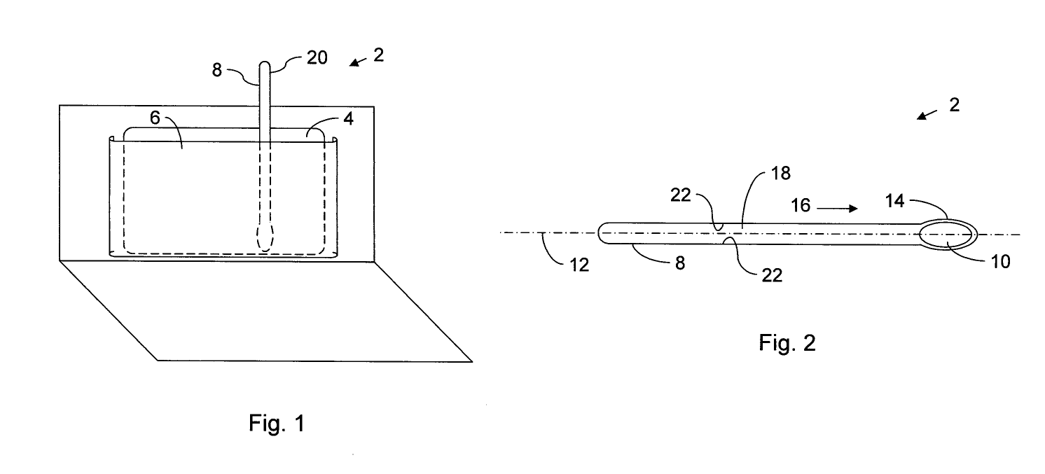

FIG. 1 shows card puller 2 for retrieving a card 4 from a card pocket 6. FIG. 2 is a perspective view of card puller 2. In one embodiment, card puller 2 includes elongated handle 8 and gripping surface 10.

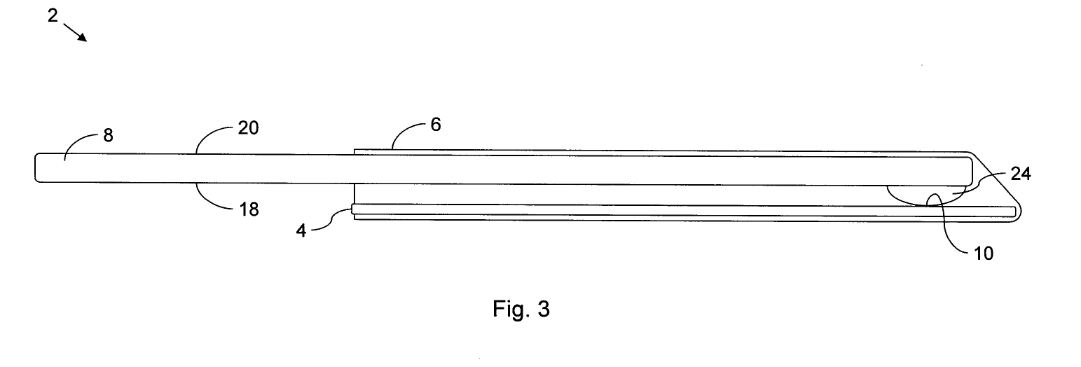

Elongated handle 8 has longitudinal axis 12. Elongated handle 8 may be formed of any suitable material, such as wood or plastic. In one embodiment, elongated handle 8 includes head 14 at one end 16. Elongated handle 8 has front 18, back 20 (FIGS. 1 and 3), and side 22 surfaces. In one embodiment, front 18 and back 20 surfaces are greater in width than side surfaces 22.

Gripping surface 10 is disposed near end 16 of elongated handle 8. In one embodiment, gripping surface 10 is disposed at end 16 of elongated handle 8. In one embodiment, gripping surface 10 is parallel to longitudinal axis 12. In one embodiment, gripping surface 10 is disposed on the front 18 surface. In one embodiment, gripping surface 10 is disposed on head 14 of elongated handle 8.

In one embodiment, elongated handle 8 against card pocket 6 has a coefficient of friction inadequate to grip card pocket 6 or card 4 in card pocket 6 as elongated handle 8 is withdrawn from card pocket 6. The inadequate coefficient of friction allows elongated handle 4 to easily slip between card 4 and card pocket 6. Additionally, when card 4 is one of a plurality of cards 4 in card pocket 6, elongated handle 4 slips easily between cards 4.

Conversely, gripping surface 10 against card 4 has a sufficient coefficient of friction to pull card 4 from card pocket 6 as elongated handle 8 is withdrawn from card pocket 6. In one embodiment, gripping surface 10 against card 4 has a greater coefficient of friction than elongated handle 8 against card 4.

In one embodiment, gripping surface 10 is affixed to elongated handle 8. Alternatively, gripping surface 10 is integral with elongated handle 8.

FIG. 3 is a cross-sectional diagram with proportions exaggerated in order to illustrate card puller 2 in use. In one embodiment, card puller 2 further includes gripping pad 24. Gripping pad 24 includes gripping surface 10. In one embodiment, gripping pad 24 and gripping surface 10 are formed of a rubber compound or other suitable elastic material having a high coefficient of friction against plastic credit cards and identification cards.

The foregoing description is only illustrative of the invention and not intended to be exhaustive or to limit the invention to the precise forms disclosed. Various alternatives and modifications can be devised by those skilled in the art without departing from the invention. Accordingly, the present invention embraces all such alternatives, modifications, and variances that fall within the scope of the appended claims.

What is claimed is:

1. A card puller for retrieving a card from a card pocket, the card puller comprising:
an elongated handle and
a gripping surface disposed near one end of the elongated handle, wherein the gripping surface against the card has a sufficient coefficient of friction to pull the card from the card pocket as the elongated handle is withdrawn from the card pocket.

2. The card puller of claim 1 wherein the gripping surface is disposed at the one end of the elongated handle.

3. The card puller of claim 1 wherein the elongated handle has a longitudinal axis and the gripping surface is parallel to the longitudinal axis.

4. The card puller of claim 1 wherein the gripping surface is affixed to the elongated handle.

5. The card puller of claim 1 further including a gripping pad, wherein the gripping pad includes the gripping surface.

6. The card puller of claim 1 wherein the elongated handle against the card pocket has a coefficient of friction inadequate to grip the card in the pocket as the elongated handle is withdrawn from the card pocket.

7. The card puller of claim 1 wherein the gripping surface against the card has a greater coefficient of friction than the elongated handle against the card.

8. The card puller of claim 1 wherein the elongated handle has front, back, and side surfaces, the gripping surface disposed on the front surface, the front and back surfaces greater in width than the side surfaces.

9. The card puller of claim 1 wherein the elongated handle includes a head at one end, the gripping surface disposed on the head of the elongated handle.

10. A card puller for retrieving a card from a card pocket, the card puller comprising:
an elongated handle and
an elastic gripping surface disposed near one end of the elongated handle.

11. The card puller of claim 10 wherein the gripping surface is disposed at the one end of the elongated handle.

12. The card puller of claim 10 wherein the elongated handle has a longitudinal axis and the gripping surface is parallel to the longitudinal axis.

13. The card puller of claim 10 wherein the gripping surface is affixed to the elongated handle.

14. The card puller of claim 10 further including a gripping pad wherein the gripping pad includes the elastic gripping surface.

15. The card puller of claim 10 wherein the elongated handle against the card pocket has a coefficient of friction inadequate to grip the card in the pocket as the elongated handle is withdrawn from the card pocket.

16. The card puller of claim 10 wherein the gripping surface against the card has a greater coefficient of friction than the elongated handle against the card.

17. The card puller of claim 10 wherein the elongated handle has front, back, and side surfaces, the gripping surface disposed on the front surface, the front and back surfaces greater in width than the side surfaces.

18. The card puller of claim 10 wherein the elongated handle includes a head at one end, the gripping surface disposed on the head of the elongated handle.
